(19) United States
(12) Patent Application Publication
(10) Pub. No.: US 2011/0148771 A1
(43) Pub. Date: Jun. 23, 2011

(54) TOUCH PANEL

(76) Inventor: Teh-Zheng Lin, Taoyuan (TW)

(21) Appl. No.: 12/642,863

(22) Filed: Dec. 21, 2009

(51) Int. Cl. G06F 3/041

(52) U.S. Cl. 345/173

(57) ABSTRACT

A touch panel includes a touch sensing layer, substrate, and a touch sensing unit between the touch sensing layer and the substrate. At least one surface of the substrate has protruded and concave stripes. The stripes are formed by etching, printing, sand blasting, or molding. The protruded and concave stripes are formed side by side and parallel. A drop height between a top of the protruded stripe and a bottom of the concave stripe is between 1 nm to 1 μm. Pitches between two adjacent concave stripes and two adjacent protruded stripes are between 1 μm to 0.1 mm, and a ratio of widths of the protruded stripe and the concave stripe is between 0.2 to 5. Interference of lights such as the Newton-Ring and highlights will be avoided by the protruded stripes and concave stripes of the substrate.

### FIELD OF THE PRESENT INVENTION

The present invention relates to touch panel, and particular to a touch panel capable of preventing interferences of lights such as the Newton-Ring and highlights.

### DESCRIPTION OF THE PRIOR ART

Prior touch panel such as a resistive touch panel includes two sheets of transparent conductive film arranged with a predetermined gap. An upper conductive film is arranged to a bottom surface of a flexible transparent touch film, and a lower conductive film is arranged to an upper surface of the transparent glass substrate. A plurality of protruding spacers is arranged between the two conductive films so that a space is formed between the films. The substrate is attached to a bottom surface of the touch film with the conductive films sealed inside. As we all know, lights passing through such stacking plate mentioned above will have the Newton-Ring which damages image shown on the screen. An anti Newton-Ring (ANR) thin film is usually arranged in the touch panel to eliminate the interference stripe. However, an additional ANR for the touch panel will cause higher cost and raise defective rate of the manufacturing. Known ANR thin film is a thin film having an uneven and rough surface thereof, or having wrinkles or stripes arranged to the surface of the thin film so that the interference stripe will be distorted by the rough surface partially refracting or reflecting the lights passing through. But the protruding and concave structure will also condense or scatter the lights so that highlights will appear on the surface. The highlights will cause distortion of the image especially to the high resolution screen or high brightness LCD.

### SUMMARY OF THE PRESENT INVENTION

Accordingly, the primary object of the present invention is to provide a touch panel with anti Newton-Ring function so as to prevent the light interference such as Newton-Ring and highlights and also to simplify manufacturing process for saving cost and improving yield.

To achieve above objects, the present invention provides a touch panel having a touch sensing layer, substrate, and a touch sensing unit between the touch sensing layer and the substrate. At least one surface of the substrate has protruded and concave stripes. The substrate is a physical transparent hard plate. At least one surface of the substrate has a plurality of protruded stripes and concave stripes. The touch sensing unit has two separate transparent conductive films formed to the touch sensing layer and the substrate respectively. Interference of lights such as the Newton-Ring and highlights will be avoided by the protruded stripes and concave stripes of the substrate.

The protruded and concave stripes are formed side by side and parallel. Preferably, a drop height between a top of the protruded stripe and a bottom of the concave stripe is between 1 nm to 1 μm. Pitches between two adjacent concave stripes and adjacent protruded stripes are between 1 μm to 0.1 mm, and a ratio of widths of protruded stripe and concave stripe is between 0.2 to 5.

The stripes are formed by etching, printing, sand blasting, or molding.

The substrate is a physical transparent hard plate made of a hard material such as polycarbonate (PC), polyethylene terephthalate (PET), Polyethersulfone (PES), Polymethylmethacrylate (PMMA), or Cyclic Olefin Copolymer (COC), but not confined within the above materials.

### BRIEF DESCRIPTION OF THE DRAWINGS

FIG. 1 is a cross section view showing a part of an embodiment of the present invention; and

FIG. 2 is an enlarged view showing section A on FIG. 1.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention not to be used to confine the scope and spirit of the present invention defined in the appended claims.

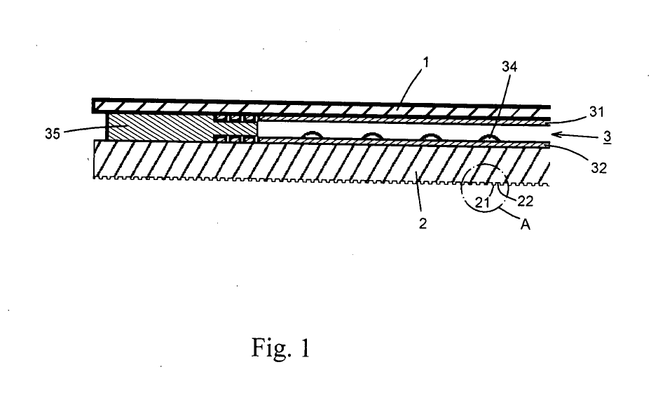

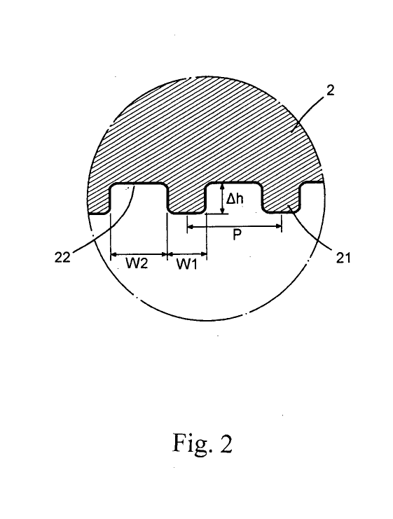

Referring to FIGS. 1 and 2, a preferable embodiment of a touch panel according to the present invention is illustrated. A touch sensing unit 3 is arranged between a touch sensing layer 1 and a substrate 2. The touch sensing layer 1 is a transparent flexible Polythylene terephthalate (PET) film. The substrate 2 is a transparent glass plate. The touch sensing unit 3 has an upper conductive film 31 and a lower conductive film 32. The upper and lower conductive films 31, 32 are transparent Indium Tin Oxide (ITO) thin film. The upper conductive film 31 is arranged to a bottom surface of the touch sensing layer 1, and the lower conductive film 32 is arranged to an upper surface of the substrate 2. A plurality of protruding spacers 34 are arranged between the upper and the lower conductive films 31, 32 so as to separate the two conductive films within an effective area. A gluing frame 35 is arranged outside the effective area of the two conductive films to glue the touch sensing layer 1 and the substrate 2 together so that the conductive films 31, 32 will be sealed inside the stacking plates. A bottom surface of the substrate 2 has a plurality of protruded stripes 21 and concave stripes 22 formed side by side through etching. The parallel stripes can be formed horizontally, vertically, or oblique to the substrate 2. For a touch panel applied to a display with a Dot Pitch between 0.264 mm to 0.282 mm, a drop height Δh between a top of the protruded stripe 21 and a bottom of the concave stripe 22 is about 0.3 μm. Furthermore, a pitch P between two adjacent concave stripes 22 or two protruded stripes is about 0.08 mm, and a ratio of widths of protruded stripe W1 and concave stripe W2 is 1.

Through above touch panel, interference of lights such as the Newton-Ring and highlights will be avoided by the protruded stripes 21 and concave stripes 22 while lights from the display pass through the touch panel.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A touch panel comprising:
a touch sensing layer being a flexible transparent thin film;
a substrate being a physical transparent hard plate; at least one surface thereof having a plurality of protruded stripes and concave stripes formed side by side; a drop height between a top of the protruded stripe and a bottom of the concave stripe is between 1 nm to 1 μm; pitches between two adjacent concave stripes and two adjacent protruded stripes are between 1 μm to 0.1 mm;
a touch sensing unit having two separate transparent conductive films formed to the touch sensing layer and the substrate respectively.

2. The touch panel as claimed in claim 1, wherein a ratio of widths of the protruded stripe and the concave stripe is between 0.2 to 5.

3. The touch panel as claimed in claim 1, wherein the substrate is made of glass.

4. The touch panel as claimed in claim 1, wherein the substrate is made of one material of polycarbonate (PC), polyethylene terephthalate (PET), Polyethersulfone (PES), Polymethylmethacrylate (PMMA), or Cyclic Olefin Copolymer (COC).
